(19) United States
(12) Patent Application Publication
(10) Pub. No.: US 2021/0230905 A1
(43) Pub. Date: Jul. 29, 2021

(54) ELECTRIC DRIVE MECHANISM FOR OPERATING A LOCK

(71) Applicant: LOON TECHNOLOGIES PTE LTD, Singapore (SG)

(72) Inventor: Kam Chin LOON, Singapore (SG)

(21) Appl. No.: 17/056,005

(22) PCT Filed: Jun. 11, 2018
(86) PCT No.: PCT/SG2018/050292

§ 371 Date: Nov. 17, 2020

(51) Int. Cl. E05B 47/02; E05B 67/24; E05B 17/00; E05B 47/00

(52) U.S. Cl. CPC E05B 47/026; E05B 67/24; E05B 17/007; E05B 2047/0023; E05B 2047/0091; E05B 2047/0095; E05B 2047/0086; E05B 47/0012

(57) ABSTRACT

This invention describes an electric drive mechanism (120) for translating a blocking member (126) to secure or release a lock. The lock is configured as a latch lock (100), a slide bolt padlock (200), a U-shackle padlock (300) or a snap padlock (400). The blocking member (126) is supported by two or more steel balls (130) disposed in helical grooves formed on a helical member (124) to provide a self-centering and low friction drive mechanism (120), which allows an electric motor (122) connected to the helical member to be small and of low power. Unobstructed movement of the blocking member (126) is provided by an alignment or detent mechanism (160, 217, 317) or torsion spring in the snap padlock (400). An electronic control board (140) allows electronic operation of the lock via an application in a smartphone. A PCB (121) located near the electric motor provides tamper-proofing.

### FIELD OF INVENTION

The present invention relates to an electric drive mechanism for operating a lock. The lock can be configured as a quarter turn latch lock (as for a locker or drawer), a slide bolt padlock, a shackle padlock or a snap padlock. The electric drive mechanism is self-centering and frictionless, or of low friction, thus consumes very low electric power and is suitable for wireless operation.

### BACKGROUND

Traditionally, locks are operated mechanically with keys. With electronic security, it appears that electronic operated locks are safer; it is also more convenient to use; however, when these electronic operated locks run out of battery power or suffer from an electronic malfunction, there is a lot of inconvenience. Each type of lock has its own advantages. It is thus desirable to have a lock that is operable both mechanically and electronically; such a lock should preferably have very low power consumption.

### SUMMARY

The following presents a simplified summary to provide a basic understanding of the present invention. This summary is not an extensive overview of the invention, and is not intended to identify key features of the present invention. Rather, it is to present some of the inventive concepts of this invention in a generalised form as a prelude to the detailed description that is to follow.

The present invention seeks to provide low power electric drive mechanisms for operating various embodiments of lock units. These are provided by a blocking member, which is translated by turning rotary-linear motion transfer mechanisms to lock or release the lock units. The rotary-linear motion transfer mechanism comprises several embodiments of self-centering and frictionless drive mechanisms or low friction drive mechanisms. The lock is configured in a quarter turn latch lock, a slide bolt padlock, a U-shackle padlock or a snap padlock. To ensure unobstructed movement of the blocking member, an alignment unit, spring detent mechanism or alignment member is used; such alignment, detent mechanism or alignment member allows the electric motor connected to the drive mechanism to be small in size and low in power consumption; an advantage of the above locks is that the locks are operable electronically via an application in a smartphone.

In one embodiment, the present invention provides a lock unit comprising a rotary-linear motion transfer mechanism, a blocking member connected to the rotary-linear motion transfer mechanism; an electric motor connected to drive the rotary-linear motion transfer mechanism; wherein, when the electric motor is activated to rotate, the blocking member is translated linearly between a locked position and a release position, with the blocking member in the locked position for securing a lock constituting the lock unit, and the blocking member in the release position for releasing the lock. Preferably, the rotary-linear motion transfer mechanism comprises a helical member having helical groove(s) with a predetermined number of start(s) engageable with cooperating helical groove(s) formed in a hollow interior of the blocking member; and at least two steel balls disposed in the helical grooves or a steel ball disposed in each helical groove with the at least two steel balls or each steel ball being located within a respective hole formed through a wall thickness of the hollow blocking member, such that the at least two steel balls are located substantially opposite each other, so that the at least two steel balls support the helical member in a self-centering manner and the at least two steel balls roll in a frictionless manner.

Preferably, a gear unit is coupled to the electric motor, so that an output shaft of the gear unit is operable to drive the rotary-linear motion transfer mechanism.

In another embodiment, the blocking member is disposed co-axially in a hollow block sleeve, with one end of the hollow block sleeve having a threaded hole aligned transversely to the hollow interior of the block sleeve; a set screw disposed in the transverse threaded hole; and wherein the rotary-linear motion transfer mechanism comprises a helical groove formed on an output shaft of a gear unit, with the gear unit being coupled to the electric motor whilst the set screw couples the block sleeve to the helical groove on the output shaft of the gear unit, so that the blocking member is actuatable to translate linearly between the locked position and the release position by rotating the gear unit and the electric motor. Preferably, a tip of the set screw sits in and engages with the helical groove, or a ball tip of the set screw sits in and is enabled to roll along the helical groove.

In another embodiment, the blocking member has an interior hollow, with one end of the interior hollow being formed with an internal screw thread; the blocking member is disposed co-axially in a hollow block sleeve; and the rotary-linear motion transfer mechanism comprises an exterior screw thread that matches and engageable with the internal screw thread of the blocking member, with both the internal and exterior screw threads having a predetermined number of start(s), and with the exterior screw thread being formed on an output shaft of a gear unit, which gear unit is coupled to the electric motor.

In another embodiment, the the rotary linear motion transfer mechanism comprises a pivot member formed with helical groove(s) that goes/go through the pivot member, with the helical groove(s) engaging with cooperating helical groove(s) formed on an output shaft of a gear unit, which gear unit is coupled to the electric motor.

Preferably, the lock unit comprises an electronic control unit that is accessible from an exterior of the lock, and a motor PCB that is located near the electric motor and located inside the lock, so that a control line is located on the motor PCB to prevent tamper operation of the electric motor by an external power or signal; preferably, the electronic control unit provides wireless communication and allows electronic operation of the lock unit via an application in a smartphone. Preferably, the lock unit is configured as a quarter turn latch lock, a slide bolt padlock, a U shackle padlock or a snap padlock.

Preferably, the above helical groove, the internal screw thread or exterior screw thread is U-shaped, V-shaped, square-shaped or trapezoid-shaped.

In yet another embodiment, the present invention provides a kit for configuring a quarter turn latch lock. The latch lock comprises: a lock unit according to any one of claim 1-14 or 16-21 for detachable mounting on a latch bar of a quarter turn latch lock; a clamp plate or plate with accompanying screws, bolts and nuts or clip for detachable mounting of the lock unit on the latch bar; a latch bar that can be modified by making it shorter and/or by bending; a latch bar that is C-shaped for configuring the lock unit for a drawer; and an electronic control unit to allow wireless operation of the lock unit via an application in a smartphone. Preferably, the latch lock also comprises an alignment unit that locates an associated door, cover or drawer with an engaging stopper member.

### BRIEF DESCRIPTION OF THE DRAWINGS

This invention will be described by way of non-limiting embodiments of the present invention, with reference to the accompanying drawings, in which:

FIG. 1A illustrates a known quarter turn latch lock, whilst FIG. 1B illustrates an exploded view of the quarter turn latch lock shown in FIG. 1A;

FIG. 2A illustrates a latch lock mounted on a letter box cover according to an embodiment of the present invention; FIGS. 2B-2D illustrate a lock unit mounted onto a latch bar of the latch lock shown in FIG. 2A; FIGS. 2E-2F illustrate use of the latch lock; FIGS. 2G-2H illustrate use of an alignment unit to position the lock unit at a locking position according to another embodiment;

FIGS. 3A-3C illustrate a ball drive mechanism for the above lock unit using a direct motor, whilst FIG. 3D illustrates the ball drive mechanism using a gear unit and a motor; FIGS. 3E-3G illustrate a helical drive mechanism for the above lock, and FIGS. 3H-3J illustrate a screw drive mechanism according to other embodiments;

FIG. 4A illustrates a latch bar is modified into a C-shape and the lock is operable as a drawer lock; FIGS. 4B-4C illustrate a lock unit for mounting onto a latch bar according to another embodiment;

FIGS. 5A-5F illustrate a sliding bolt padlock using the above drive mechanism, where the sliding bolt padlock is suitable for use on eyebrackets located on a gate; FIGS. 5G-5M illustrate a sliding bolt padlock using the above drive mechanism and provided with an additional key for opening the sliding bolt padlock;

FIGS. 6A-6C illustrate a shackle padlock using the above drive mechanism;

FIGS. 7A-7B illustrate a snap padlock also using the above drive mechanism; and

FIGS. 8A-8B illustrate a variation of a latch lock housing for mounting the lock unit shown in FIGS. 2A-2F.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the present invention. For ease of reference, common reference numerals or series of numerals will be used throughout the figures when referring to the same or similar features common to the figures.

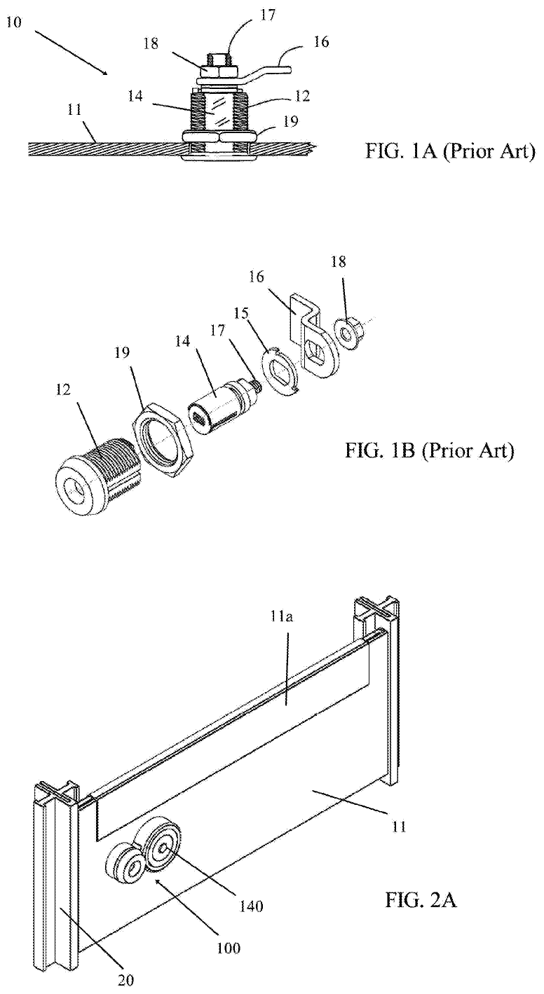

FIGS. 1A-1B show a known quarter turn latch lock 10. This quarter turn lock 10 is ubiquitous and is widely used in homes, offices, schools, etc. for securing drawers, cabinets, letter boxes, lockers, doors, covers and so on. Smartphones are also becoming ubiquitous, and it is therefore desirable and convenient to operate such locks electronically with an application in smartphones, yet allowing the lock to be mechanically operated, for example, during an emergency or before returning a rented locker/letter box. As shown in FIGS. 1A-1B, the quarter turn lock 10 is made up of a stationary housing 12, a rotary cylinder 14 disposed in the stationary housing and a latch bar 16 secured near an end of the rotary cylinder 14 on a threaded end 17 by a matching nut 18. When a key 9 matching the rotary cylinder 14 is turned, the rotary cylinder 14 and latch bar16 are unitarily rotated through a quarter turn, so that the latch bar 16 is turned between a release position and a locked position. The exterior of the stationary housing 12 is threaded and an engaging lock ring 19 allows the quarter turn lock 10 to be installed on a board or cover 11 irrespective of the board/cover thickness.

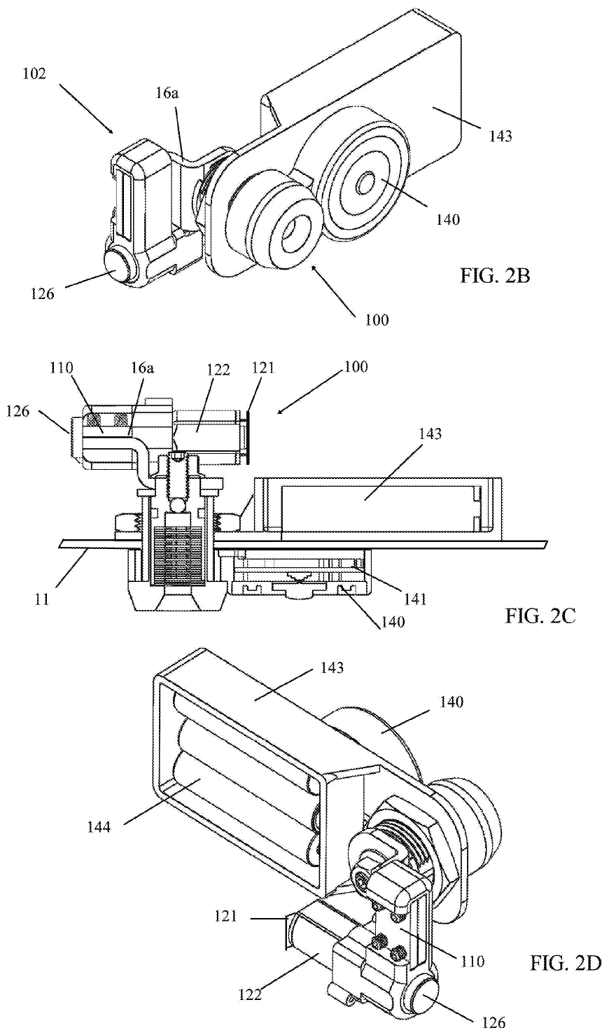

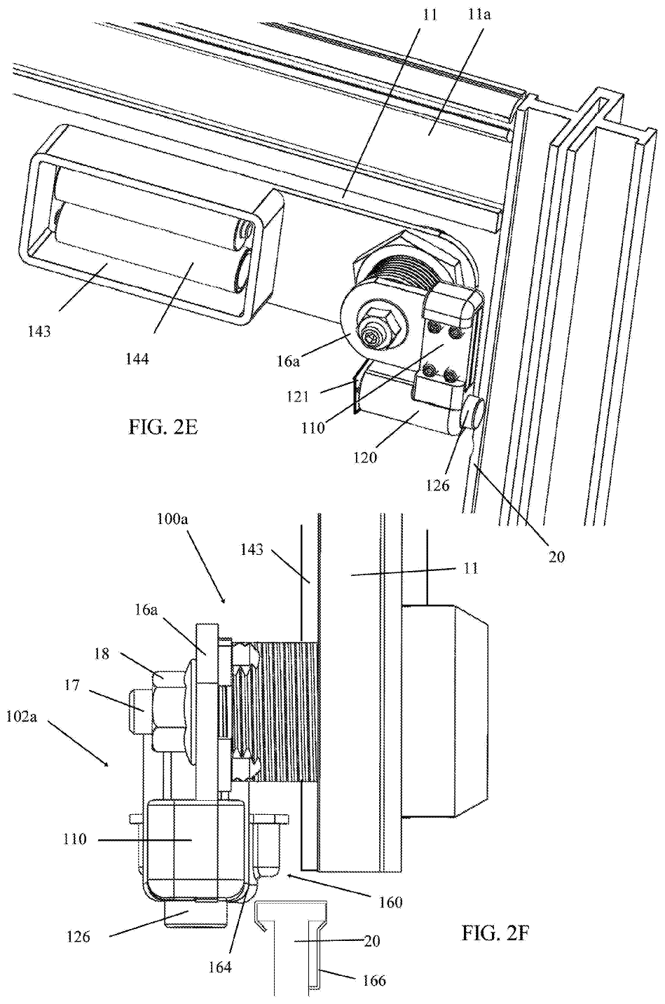

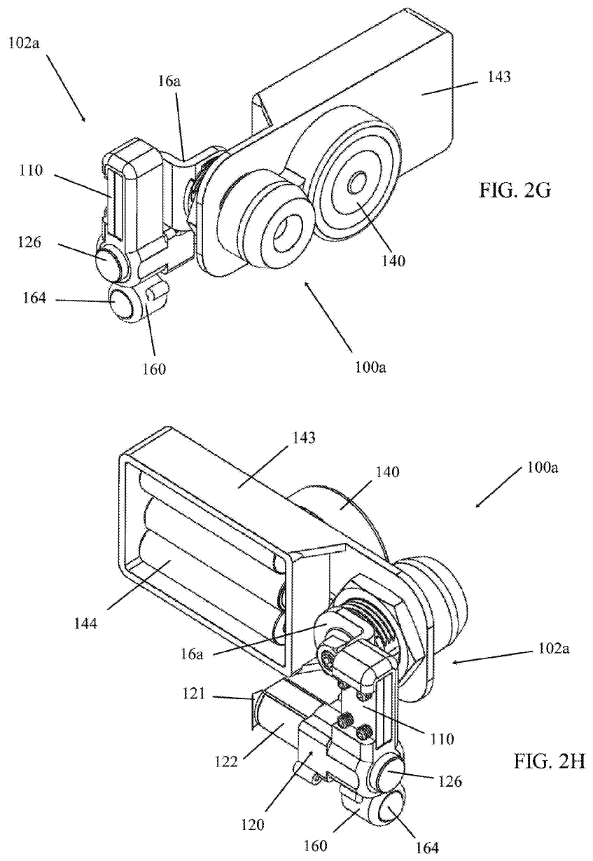

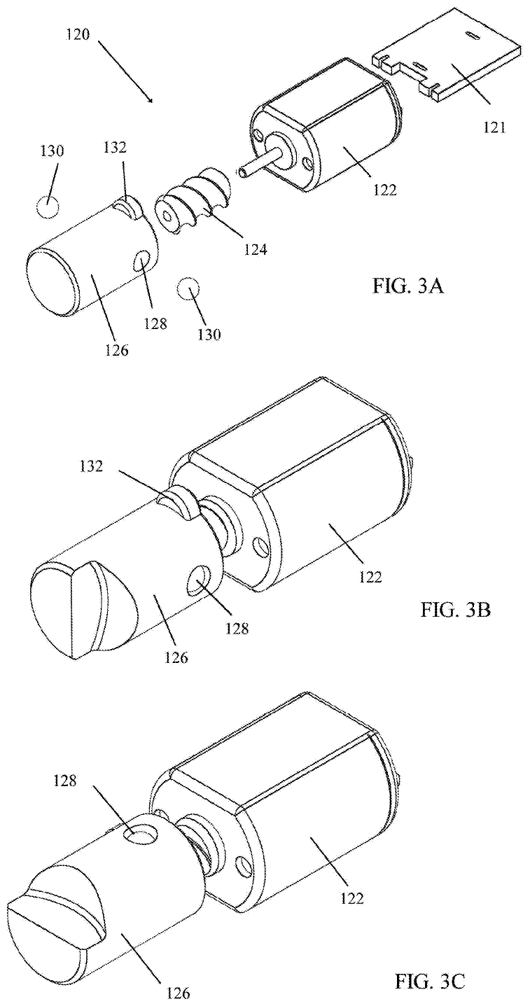

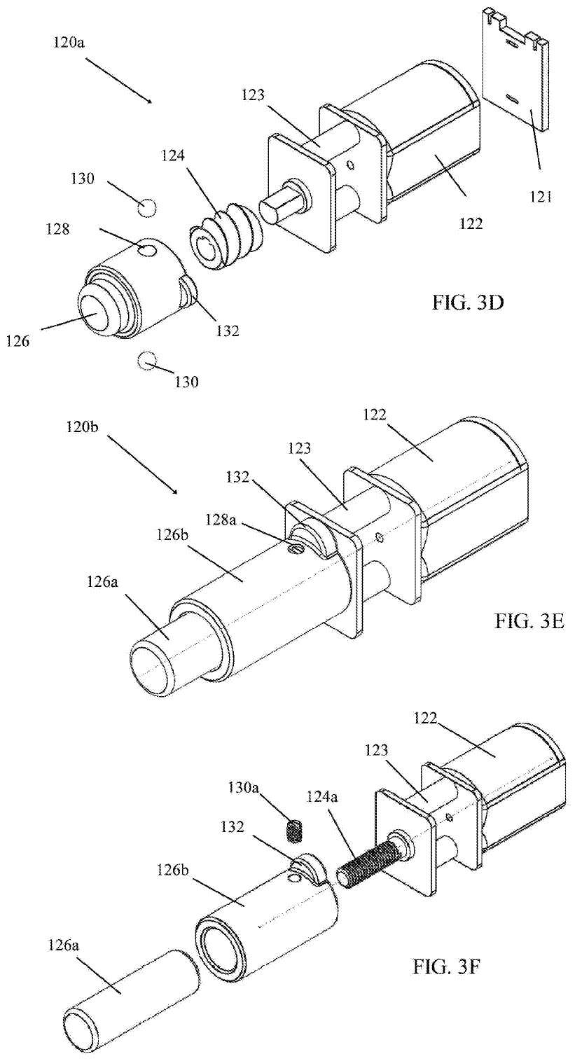

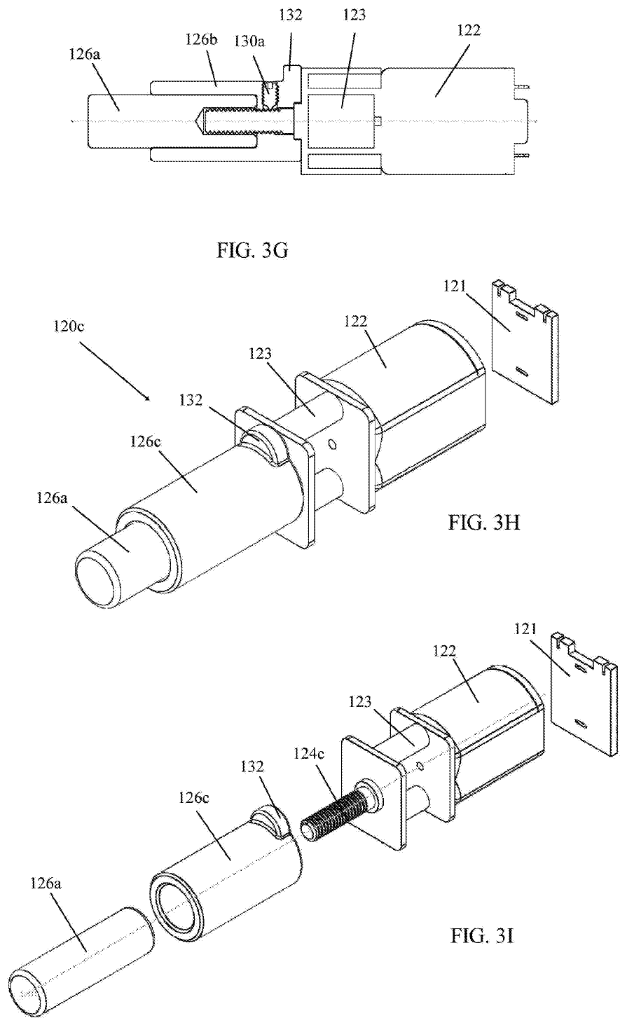

FIG. 2A shows a latch lock 100 mounted on a letter box/locker cover 11 according to an embodiment of the present invention. The letter box has a pivoted flap 11a for inserting postal material into the letter box. FIG. 2B shows a front perspective view of the latch lock 100, whilst FIG. 2C shows a cross-sectional view of the latch lock and FIG. 2D shows an inside perspective view. The use of the latch lock 100 is more clearly shown in FIGS. 2E-2F. As seen in the figures, the latch lock 100 is made up of a lock unit 102 mounted on a latch bar 16a, an electronic control unit 140 mounted on an exterior of the door/cover 11 and a battery holder 143 mounted on an inside of the door/cover 11. The battery 144 is accessible when the letter box/locker is open. The lock unit 102 is removeably attached onto the latch bar 16a by a clamp plate 110 and accompanying screws 112; the latch bar 16a may be modified from an existing latch bar 16 by making it shorter or by replacing an existing latch bar so that in the locking position, the latch bar 16a does not engage with a stopper member 20 (which forms a stationary, structural part of the letter box as seen in FIG. 3E), such that when the lock unit 102 is mounted on the latch bar 16a, a blocking member 126 of the lock unit 102 is extendable to engage with the stopper member 20 at the locked position. When put to use for the first time, a key 9 matching the rotary cylinder 14 turns the latch lock 100 into the locking position; the lock unit 102 is subsequently activated electronically (for e.g., via an application in a smartphone) to translate the blocking member 126 into or out of the locked position. In the event of an electronic malfunction or power failure, the key 9 can still be used to turn the latch bar 16a to lock or unlock the letter box door 11 provided the blocking member 126 is already extended. If malfunction/power failure occurs with the blocking member 126 being in the retract position, the latch bar 16a and/or lock unit 102 can be easily replaced.

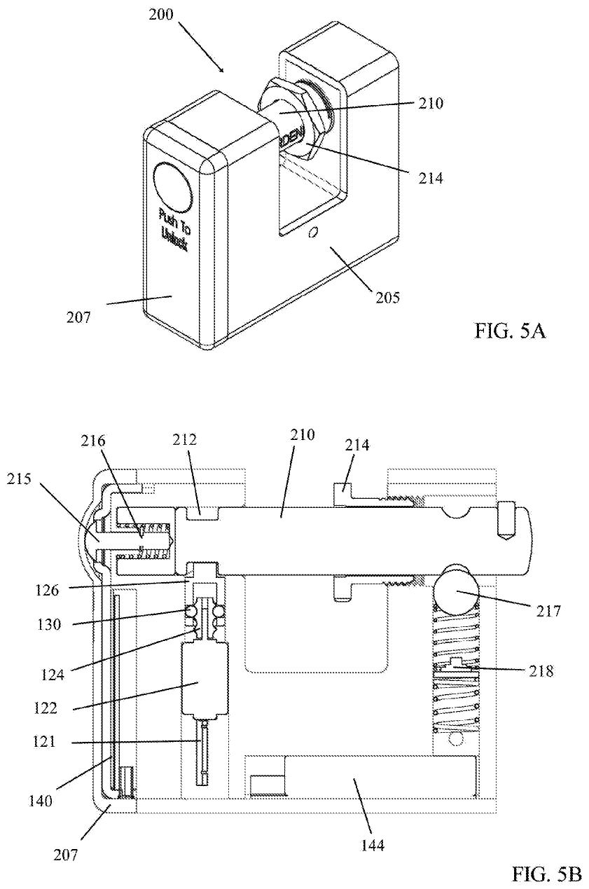

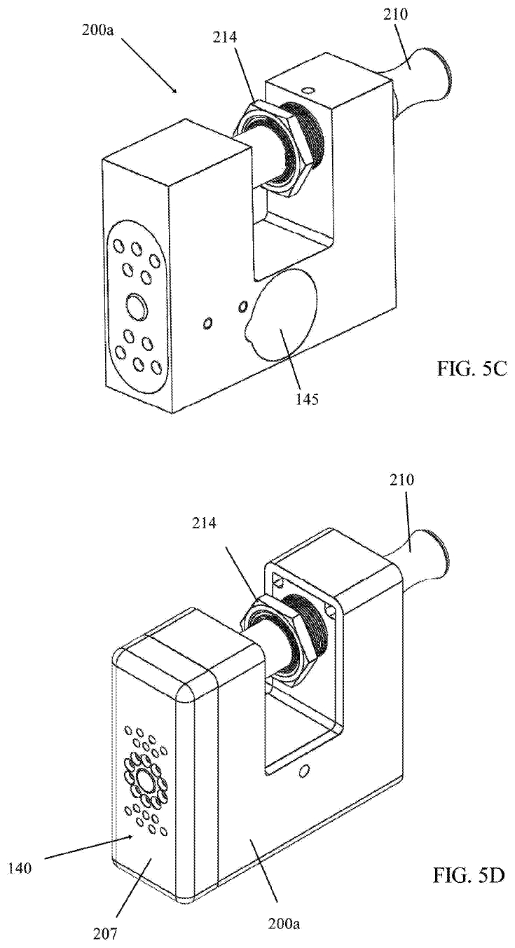

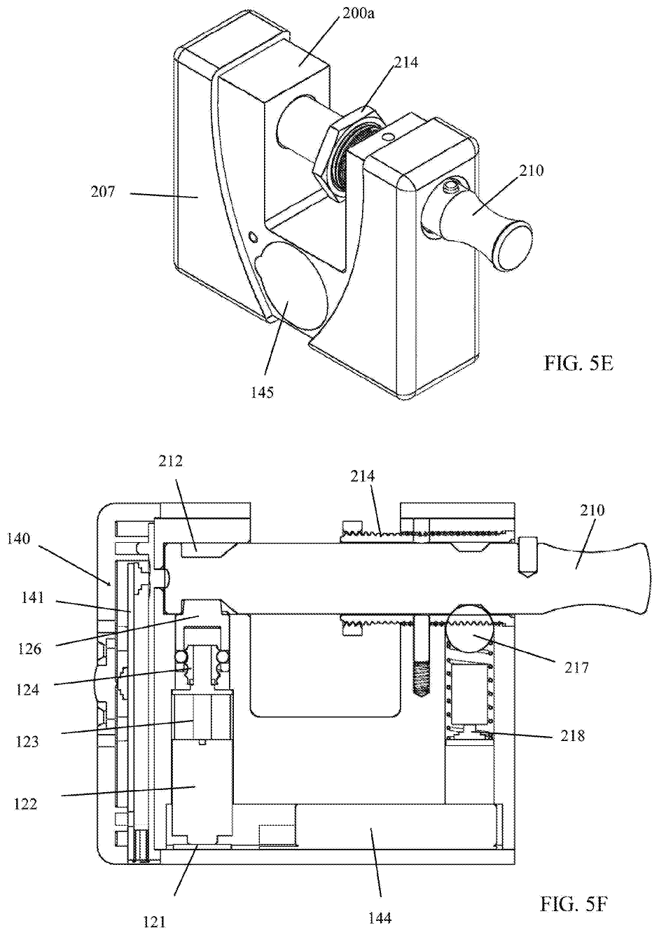

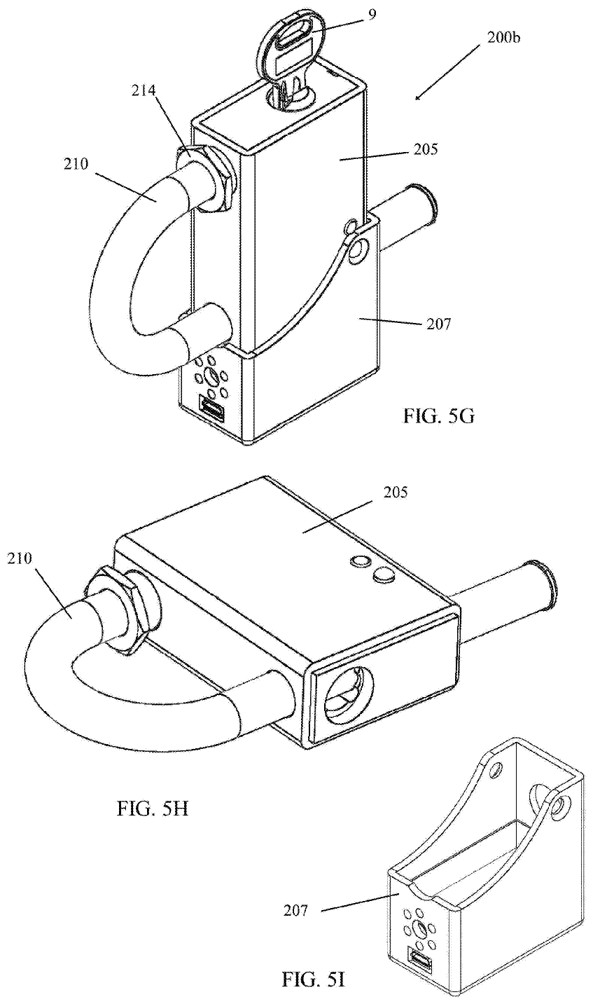

Whilst not shown in detail, the electronic control unit 140 includes a PCB 141, a processor for controlling logic of operation, preferably with a sensor or switch, components for Bluetooth, wifi, etc. communication, antenna, memory unit, and so on. The electronic control unit 140 is electrically connected to a motor PCB 121, with the motor PCB 121 being located near an electric motor 122 and disposed inside the letter box. In the event that the electronic control unit 140 is tampered with, any attempt to supply electric power or signal through exposed wires at the electronic control unit 140 will not operate the electric motor 122 because at least one control line is located on the motor PCB 121, which the at least one control line remains inside the locked letter box/locker. Depending on the processor and components in the electronic control unit 140, the battery 144 can be supplied in various capacities, forms and sizes, such as a button type, and a corresponding battery cover 145 shown in FIGS. 5C and 5E.

To ensure the blocking member 126 is aligned with the stopper member 20 at the locking position, an alignment unit 160 is provided adjacent to a lock unit 102a according to a variation. FIGS. 2F-2H show the above lock unit 102a is integrally formed with the alignment unit 160. The alignment unit 160 includes a casing 162 to hold a spring-loaded steel ball 164. The steel ball 164 extends out of the casing 162 and is depressible; when the locker/letter box door or cover 11 is closed, contact between the steel ball 164 and the stopper member 20 defines the locking position of the locker/letter box cover or door. With this alignment unit 160, movement of the blocking member 126 would be guided to a side of the stopper member 20 during locking, i.e. without any obstruction to movement of the blocking member 126 during locking; ensuring that movement of the blocking member is unobstructed, the electric motor 122 used to drive the blocking member 126 can then be small in size, with a corresponding low power consumption.

Typically, the letter box is constructed using aluminium parts. Aluminium parts are soft. In a variation, a part of the stopper member 20 that engages with the alignment unit 160 is protected by a metal protection clip 166, as shown in FIG. 2F. In one embodiment, the metal protection clip 166 is made of stainless steel, steel or a suitable hard, durable material to prolong the life of the stopper member 20 from damage or wear and tear. The metal protection clip 166 may be additionally secured onto the stopper member 20 by a screw, adhesive or other suitable method.

Now, a drive mechanism of the blocking member 126 is described. FIG. 3A shows an exploded view of a ball drive mechanism 120, whilst FIGS. 3B-3C show the blocking member 126 is in the respective retracted and extended positions. As seen from FIG. 3A, a helical member 124 is connected to a drive shaft of the electric motor 122. The helical member 124 has two helical grooves (i.e. double start grooves); preferably, the helical groove is U-shaped; the blocking member 126 has a hollow interior which is open at one end; the open, hollow end of the blocking member is dimensioned to receive the helical member 124, whilst the closed end is for securing or releasing the lock unit 102, 102a. The open, hollow end of the blocking member 126 has two substantially opposite radial holes 128 that go through a wall thickness at the open, hollow end. These radial holes 128 are dimensioned to receive two steel balls 130, each being inserted to sit in the respective helical groove on the helical member 124. The wall thickness at the hollow end of the blocking member 126 is smaller than the diameter of the steel balls 130 such that the steel balls 130 do not project out of the cylindrical surface of the blocking member 126. The two substantially opposite steel balls 130 thus support the blocking member 126 in a self-centering and frictionless manner. The steel balls 130 are kept in position by a cylindrical hole in which the blocking member 126 slides in. The cylindrical hole has an axial groove to receive a projection 132 formed on an exterior surface of the blocking member 126, as seen in FIGS. 3A-3B; the blocking member 126 is thus constrained to slide in a linear manner, so that rotation of the electric motor 122 and helical member 124 cause linear translation of the blocking member 126 in a frictionless manner as aided by rolling of the two opposite steel balls 130; in other words, as the helical member 124 is rotated, the steel balls 130 roll along the respective helical grooves in a frictionless manner, thereby causing the blocking member 126 to translate linearly between a locked position and a lock release position; for example, the blocking member 126 is actuated to translate through a distance of substantially 3-5 mm, depending on a pitch, numbers of starts of the helical grooves and dimensions of the helical grooves, and size of the steel balls. Depending on the design and size of the ball drive mechanism 120, it is also possible to use a single-start groove, three-starts or even four-starts helical grooves, such that the helical member 124 is supported by two substantially opposite steel balls 130 or three steel balls 130. In one embodiment, the electric motor 122 is a DC motor; in another embodiment, the electric motor 122 is a DC stepper motor. When the electric motor 122 is a DC or stepper motor, the blocking member 126 is made of a non-magnetic material, such as, polyacetal, brass, aluminium and so on. A non-magnetic material ensures that the blocking member 126 cannot be moved from its intended position by tampering the lock unit 102, 102a with an external magnetic field.

In another embodiment, FIG. 3D shows a ball screw drive 120a with the electric motor 122 driven by a gear unit 123; the output shaft of the gear unit 123 is connected to the helical member 124; with the gear unit 123, the blocking member 126 cannot be easily displaced from its intended position by tampering with an external magnetic field; thus, the blocking member 126 can be made of a magnetic material, such as steel; it is also possible that the gear unit 123 is integrated inside the electric motor 122. In another embodiment, it is possible to supply a polymer sleeve (disposed in the cylindrical hole) to receive the blocking member 126; the polymer sleeve has a longitudinal groove or slit for receiving the projection 132; preferably, the polymer sleeve has low friction and is selected to withstand a relatively high temperature; a suitable polymer is polyacetal.

In FIGS. 3A-3D, the helical grooves are shown on a separate helical member that is detachably connected to an output shaft of the electric motor or gear unit. In contrast, in FIGS. 3E-3G the helical grooves are formed on the output shaft of the gear unit; the helical groove formed integrally with the output shaft of the gear unit constitutes a helical drive mechanism 120b according to another embodiment. As shown in FIGS. 3E-3G, the helical drive mechanism 120b includes the output shaft of the gear unit 123 being formed with a helical groove 124a, an electric motor 122 to drive the gear unit 123, a blocking member 126a located in a block sleeve 126b and the helical groove 124a is connected to the block sleeve 126b via a set screw 130a; a tip of the set screw 130a engages with the helical groove 124a, so that when the gear unit 123 is actuated by the electric motor 122, rotation of the helical groove 124a is transmitted as linear translation of the blocking member 126a via the set screw 130a; in another embodiment, the tip of the set screw 130a terminates with a steel ball, which steel ball reduces friction with the helical groove 124a. With a gear unit 123, the blocking member 126a can be made of a magnetic material, such as steel, whilst the block sleeve 126b can be made of a low-friction material, such as polyacetal.

FIGS. 3H-3J show a screw drive mechanism 120c according to another embodiment. The screw drive mechanism 120c is similar to the above helical drive mechanism 120b except that the output shaft of the gear motor is formed with a screw thread 124c; the screw thread 124c can be V-shaped, square-shaped, trapezoid-shaped and so on, and like the above helical groove, the screw thread 124c can be single-start or multiple-starts. In this screw drive mechanism 120c, the engaging portion on the block sleeve 126c is similarly threaded to mate with the screw thread 124c. As in the above, when the screw thread 124c is actuated to rotate, rotation is transmitted as linear translation at the blocking member 126a for locking or unlocking of the lock unit 102, 102a.

In the above ball and helical drive mechanisms 120, 120a, 120b, the steel balls 130 or set screws 130a function like a cam follower, whilst the helical grooves function like a helical cam. In the screw drive mechanism 120c, the screw thread on the block sleeve 126c functions like a nut engaging with a male screw.

In the above embodiment, the lock unit 102 is removeably attached onto the latch bar 16a by a clamp plate 110 and accompanying screws 112; preferably, slots are formed on the latch bar 16a to allow adjustments for the screws 112 when the lock unit 102 is being aligned during setup. Alternatively, it is also possible to locate the latch bar 16a in a groove formed on the clamp plate and to secure this connecting joint with a set screw; it is also possible that the groove is just a stepped edge and screws or bolts and nuts are used to secure the two pieces together. In another embodiment, the clamp plate is just a plain piece of metal and is adjustably connected to the latch bar by screws or bolts and nuts. It is also possible that the engaging edges or surfaces of the latch bar 16a and metal plate holding the lock unit 102 are serrated or striated for positive engagement; it is also possible that positive engagement between contacting edges or surfaces are provided by matching or mating protrusions and depressions; alternatively or in addition, the engaging edges or surfaces may be bonded by an adhesive or adhesive tape or restrained from slipping with use of a non-slip interface material or coating. When the engaging edges or surfaces are positively engaged, clips instead of screws or bolts/nuts may be used to hold the two pieces together.

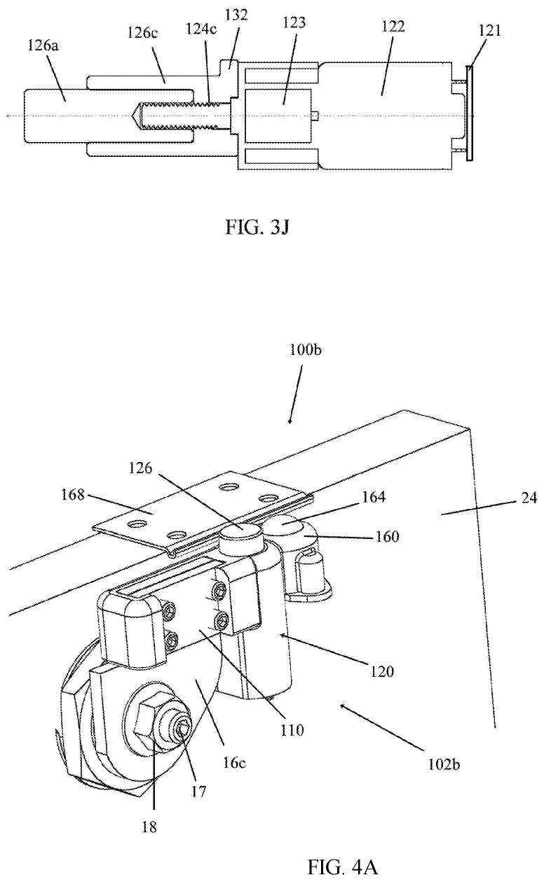

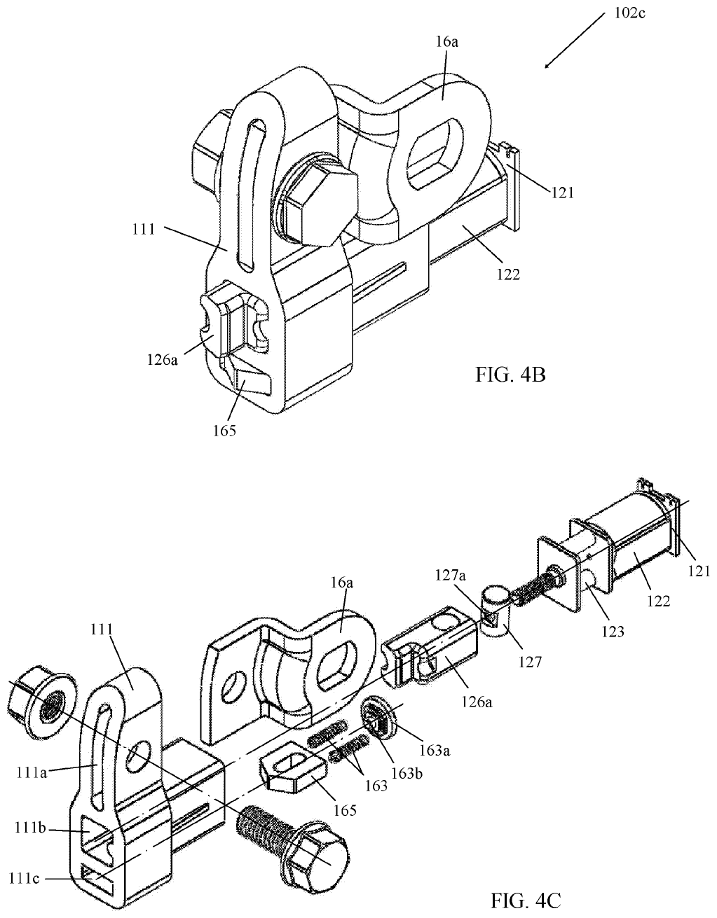

In FIGS. 2A-2H, the latch bar 16a is shown to be substantially radial but Z-shaped. It is possible that the latch bar 16b is bent in any form (as seen in 4A) so that the blocking member 126 is substantially aligned with an engaging stopper member 20. It is also possible that the latch bar 16c is C-shaped, as seen in FIG. 4A, when the lock unit 102b is used in a drawer 24. As the drawer 24 is often made of wood, a metal plate 168 is provided to protect the lock unit 102b from being tampered. As in the above embodiment, after a first time use with a key 9 to lock, locking or unlocking of the lock unit 102b is subsequently carried out electronically through an application in a smartphone.

FIGS. 4B-4C show a lock unit 102c for mounting on a latch bar 16a according to another embodiment. As shown, the lock unit 102c includes a body member 111, which has three through apertures 111a, 111b, 111c whose centrelines are substantially parallel. A part of the latch bar 16a is received and secured in the aperture 111a by a bolt and nut. Disposed to slide in the aperture 111b is a blocking member 126a. The blocking member 126a is actuated to slide by coupling a motor 122 to a gear unit 123 with an output shaft of the gear unit being threaded, connecting the threaded output shaft of the gear unit through a threaded hole 127a formed in a pivot member 127, and coupling the pivot member 127 to the blocking member 126a; in the locking position, the blocking member 126a is extended out of the body member 111 (as seen in FIG. 4B), whilst in the unlock position, the blocking member 126a is retracted into the body member 111. When the blocking member 126a is forced to open, the pivot member 127 absorbs some of the applied forces and moments; the pivot member 127 thus minimises transfer of the applied forces and moments onto the threaded shaft of the gear unit, thereby providing better utility of the lock unit 102c.

Disposed to slide in the aperture 111c is a wedge-shaped alignment member 165; the wedge-shaped alignment member 165 is biased to extend out of the body member 111 by a spring 163 (two being shown in FIG. 4C) and is kept in position by a retainer 163a; mounted on the retainer 163a is a sensor switch 163b. The wedge-shaped alignment member 165 and spring 163 serve to align the blocking member 126a when the lock unit 102c is in the locking position (much like the above alignment unit 160), so that, in the locking position, movement of the blocking member 126a is unobstructed and the motor power remains low during operation. The sensor switch 163b senses the position of the wedge-shaped alignment member 165 and works with the electronic control unit 140.

FIGS. 5A-5B show a slide bolt padlock 200 using the above linear drive mechanism 120; FIGS. 5C-5F show a slide bolt padlock 200a also using the above linear drive mechanism 120 but with the slide bolt for manual sliding; FIGS. 5G-5M show a slide padlock 200b also using the above linear drive mechanism but with an additional key for manual over-ride in the event of electronic power loss or malfunction. As shown in FIGS. 5A-5M, the slide bolt padlock 200, 200a, 200b has a slide bolt 210 and a lock bush 214. The lock bush 214 is provided for fixing the slide bolt padlock 200 to an eyebracket 30 of a gate, for example, whilst in use, the slide bolt 210 engages with cooperating eyebracket 32 located on a moveable leaf of the gate. As seen in FIGS. 5A-5M, the engaging end of the slide bolt 210 has an annular groove 212. To lock the padlock 200, 200a, 200b, the electric motor 122 is activated to rotate in a lock direction (depending on whether the helical groove is right- or left-hand), thereby extending the blocking member 126 to engage into the annular groove 212; to unlock the slide bolt padlock 200, 200a, 200b, the electric motor 122 is activated to turn in an opposite direction to retract the blocking member 126 from the annular groove 212. In FIGS. 5G-5M, in the event of an electronic malfunction or lack of battery power, a key 9 is operated on the lock cylinder 14 to retract the gear unit 123 via a connecting pin 250, thereby freeing the blocking member 126 from the annular groove 212 thereby unlocking the slide bolt padlock 200b; this is more clearly illustrated in FIGS. 5L-5M.

In FIGS. 5A-5B, the slide padlock 200 has built-in sensing and is suitable for one-hand operation; this is provided by a push button 215 located at the lock end of the slide bolt 210, together with a switch 216 connected to the push button 215. When the push button 215 is momentarily depressed, the switch 216 sends a signal to the electric motor 122 to wake the control unit 140 from a sleep mode to a ready mode for unlocking. On the other hand, to lock the slide bolt padlock 200, the slide bolt 210 is pushed into the lock position and activation of the switch 216 wakes up the control unit 140, which then instructs the electric motor 122 to rotate and to extend the blocking member 126 to engage into the annular groove 212 for locking; after a lapse of a predetermined time period, the control unit 140 puts the padlock 200 into the sleep mode to conserve electric power in the battery 144. Near the free end side of the slide bolt 210, a spring detent mechanism is provided; the spring detent mechanism includes a spring loaded steel ball 217 and an accompanying switch 218; location of the steel ball 217 in a detent 219 on the slide bolt 210 when the padlock 200 is in the locking position helps to hold the slide bolt 210 in position until a force is applied onto the slide bolt 210; the detent mechanism thus helps in the one-hand operation of the slide padlock. At the same time, the detent mechanism ensures that the blocking member 126 is unobstructed during locking and thus avoiding the electric motor 122 from unintentional overloading during operation. In addition, the switch 218 may be used in parallel with the switch 216 for electric interlock control.

As seen in FIGS. 5A-5F, the slide bolt padlock 200, 200a has a removable polymer case 207. The polymer case 207 helps to minimise hard metal contact and to avoid injury to a user in the event of an accident. In addition, the polymer case 207 protects the electronic control unit 140 disposed behind the polymer cover; a similar polymer case 207 is also provided at a lower part of the slide padlock 200b shown in FIGS. 5G-5M. Even when the polymer case 207 is tampered with, the electric motor 122 cannot be activated because the motor PCB 121 is located inside the body of the padlock 200, 200a, 200b.

Also as seen in FIGS. 5G-5M, the lock cylinder 14 is located inside the body of the padlock 200 by a locating pin 260. The lock cylinder 14 is shown as an embodiment of a mechanical locking mechanism for opening the slide bolt padlock 200b during an electronic malfunction or loss of battery power. It is possible that the slide bolt 210 can be reconfigured as a straight member or use another suitable mechanical locking mechanism, such as, a combination lock cylinder, a cam lock, a dial lock, a key pad, and so on, without detracting from the inventive concept of the above locks.

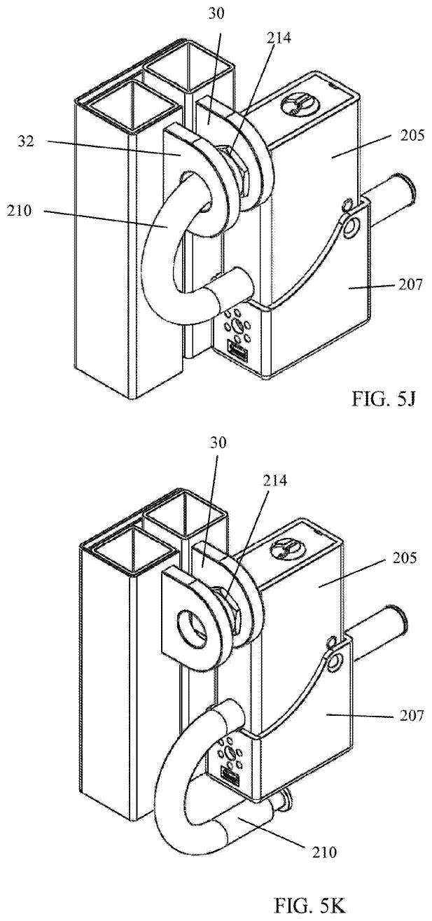

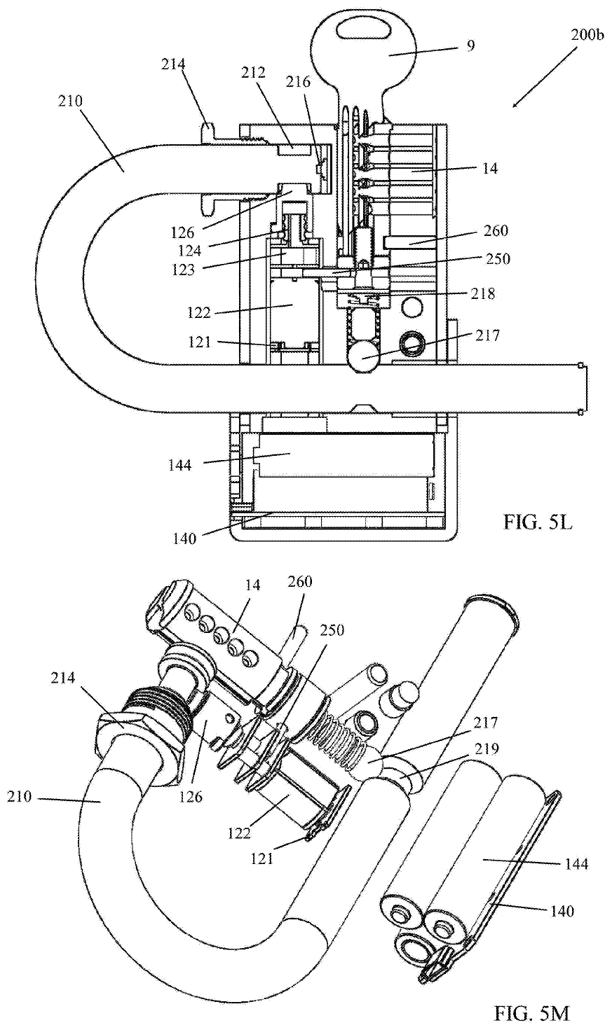

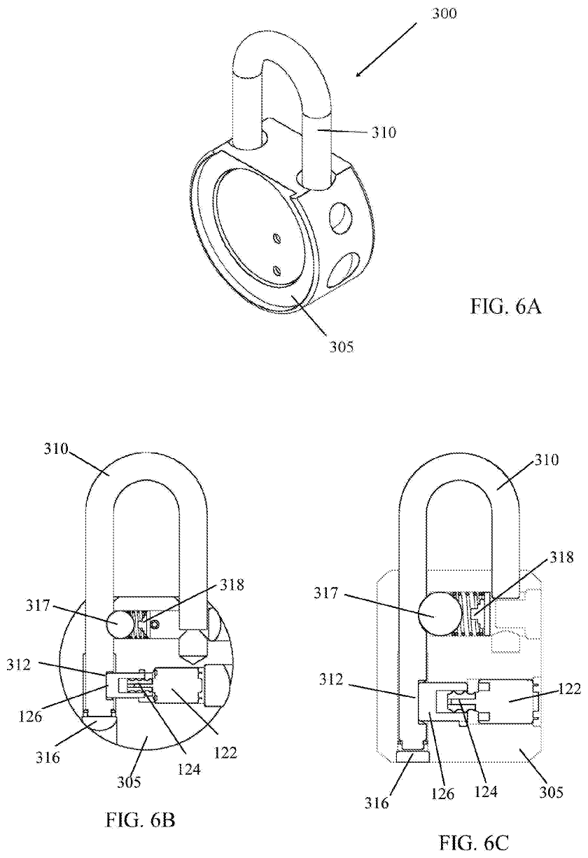

FIGS. 6A-6C show a shackle padlock 300 using the above linear drive mechanism 120. The shackle padlock 300 has a body 305 and a U-shackle 310. One end of the U-shackle has a notch 312, into which the blocking member 126 is extended for locking. It is possible that the notch 312 is formed as an annular groove. A switch 316 helps to determine the locking position of the U-shackle 310. As in the above embodiment, a spring loaded ball 317, detent and an accompanying switch 318 are provided to positively detect the locking position of the U-shackle 310. FIGS. 6A-6B show the shackle body 305 is substantially round in a front view; it is possible that the shackle body 305 be of other shape, such as, a rectangular, as seen in FIG. 6C.

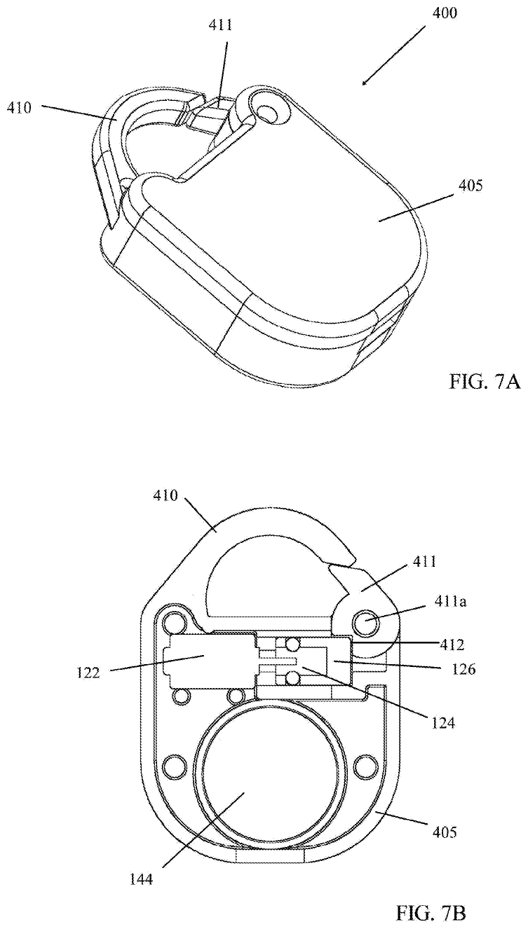

FIGS. 7A-7B show a snap padlock 400 using the above linear drive mechanism 120. The snap padlock 400 has a body 405, a fixed arcuate shackle 410 and a hinged snap member 411 that is rotatable about a pivot 411a. A portion of the snap member 411 (near the pivot 411a) has a notch 412, so that when the snap padlock 400 is in the locked position, the blocking member 126 is extended and engaged into the notch 412. When the blocking member 126 is retracted, the snap member 411 does not contact the blocking member 126 and the snap member can then be depressed to unlock the snap padlock 400. It is possible that the snap member 411 is biased in the locking position by a torsion spring (not shown in the figures) disposed inside the body 405. The torsion spring ensures that in the locking position, movement of the blocking member 126 is unobstructed, and the electric motor would not overload during locking.

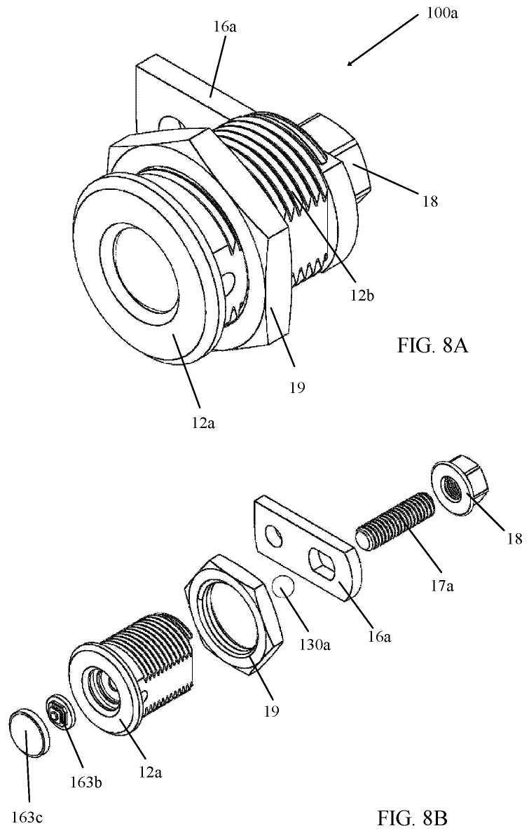

While specific embodiments have been described and illustrated, it is understood that many changes, modifications, variations and combinations thereof could be made to the present invention without departing from the scope of the present invention. For example, steel balls 130 may be done away with and the helical member is formed as a male screw member with a screw thread to engage directly with an internal screw thread formed inside the blocking member. Preferably, a low friction seal is used to keep grease inside the blocking member. Preferably, tolerances between the male screw member and the internal screw are controlled to reduce free-play between the screw member and the blocking member. In another example, a latch lock 100a is provided as a variation in FIGS. 8A-8B; as shown in FIGS. 8A-8B, the latch lock 100a provides mounting for the above lock unit 102, 102a-102c. The latch lock 100a includes an attachment housing 12a, a lock ring 19, a stud 17a, a lock nut 18 and a latch bar 16a. The lock ring 19 secures the attachment housing 12a onto the cover or door 11, whilst the lock nut 18 secures the latch lever 16a onto the stud 17a when the stud is secured axially to an inside of the attachment housing 12a. To prevent tampering of the latch lock 100a, for e.g., by drilling, a steel ball 130a is inserted between the attachment housing 12a and the stud 17a. In use, the latch lever 16a is securedly fixed in a locked position so that the lock unit 102, 102a-102c becomes operable wirelessly to lock and unlock the associated letter box, drawer, cabinet, locker door, door, closure cover, and so on. To reduce electric power consumption, a tag switch/sensor 163b is provided at a front end of the attachment housing 12a, so that before a user uses the lock unit 102, 102a-102c, the user activates the lock unit from a sleep mode by depressing the tag switch/sensor 163b. Preferably, a depressable soft cover 163c is provided to protect the tag switch 163b. Further, the control unit 140 can now be located inside the letter box, drawer, cabinet, door, etc.. With this latch lock 100a, there is no need to provide the rotary cylinder 16 and the physical key 9.

1. A lock unit comprising:
a rotary-linear motion transfer mechanism; comprising:
a helical member having helical groove(s) with a predetermined number of start(s) engageable with cooperating helical groove(s) formed in a hollow interior of a blocking member, wherein the blocking member connected to the rotary-linear motion transfer mechanism; and at least two steel balls disposed in the helical grooves or a steel ball disposed in each helical groove with the at least two steel balls or each steel ball being located within a respective hole formed through a wall thickness of the hollow blocking member, such that at least two steel balls are located substantially opposite each other, so that the at least two steel balls support the helical member in a self-centering manner and the at least two steel balls roll in a frictionless manner; and
an electric motor is connected to drive the rotary-linear motion transfer mechanism; such that, when the electric motor is activated to rotate, the blocking member is translated linearly between a locked position and a release position, with the blocking member in the locked position for securing a lock constituting the lock unit, and the blocking member in the release position for releasing the lock.

2. (canceled)

3. The lock unit according to claim 1, wherein:
a wall thickness of the blocking member is less than a diameter of the steel ball.

4. The lock unit according to claim 1, wherein an exterior surface of the blocking member has a projection and the projection is received in an axial groove formed along a receiving hole to provide a linear constraint to the blocking member.

5. The lock unit according to claim 1, Wherein the electric motor is configured as an electric gear motor.

6. (canceled)

7. (canceled)

8. (canceled)

9. (canceled)

10. (canceled)

11. (canceled)

12. (canceled)

13. The lock unit according to claim 1, further comprising an electronic control unit that is accessible from an exterior of the lock, and a motor PCB that is located near the electric motor and located inside the lock, so that a control line is located on the motor PCB and is inaccessible from an exterior of the lock to prevent tamper operation of the electric motor by an external power or signal.

14. The lock unit according to claim 13, wherein the electronic control unit provides wireless communication and allows electronic operation of the lock unit via an application in a smartphone.

15. The lock unit according to claim 13 is configured as a quarter turn latch lock, a slide bolt padlock, a U shackle padlock or a snap padlock.

16. The lock unit according to claim 15 is detachably mounted on a latch bar of the quarter turn latch lock.

17. (canceled)

18. (canceled)

19. (canceled)

20. The lock unit according to claim 16 further comprising an alignment unit or an alignment member disposed adjacent to the blocking member to align the locking position with an engaging stopper member.

21. The lock unit according to claim 20, further comprising a protection clip attachable to the engaging stopper member to avoid damage or wear on the stopper member.

22. The lock unit according to claim 15, wherein the blocking member is engageable in an annular groove formed at a locking end of a slide bolt of the slide bolt padlock.

23. The lock unit according to claim 22, further comprising a push button and an accompanying switch for toggling the lock unit between a sleep mode and a wake-up mode.

24. (canceled)

25. The lock unit according to claim 15, wherein the blocking member is engageable in a groove formed at a locking end of a U-shackle of the shackle padlock.

26. (canceled)

27. (canceled)

28. (canceled)

29. (canceled)

30. (canceled)

31. (canceled)
